(19) United States
(12) Patent Application Publication
(10) Pub. No.: US 2026/0148676 A1
(43) Pub. Date: May 28, 2026

(54) DISPLAY DEVICE AND METHOD OF DRIVING THE SAME

(71) Applicant: LG Display Co., Ltd., Seoul (KR)

(72) Inventors: Min Kyu CHUN, Paju-si (KR); Young Mi KIM, Paju-si (KR); Young Jun CHOI, Paju-si (KR)

(73) Assignee: LG Display Co., Ltd., Seoul (KR)

(21) Appl. No.: 19/341,645

(22) Filed: Sep. 26, 2025

(30) Foreign Application Priority Data
Nov. 28, 2024 (KR) 10-2024-0173646

(51) Int. Cl. G09G 3/20

(52) U.S. Cl. CPC G09G 3/2092; G09G 2300/043; G09G 2300/0819; G09G 2310/0267

(57) ABSTRACT

A display device includes a gate driving circuit including a Q-node controller configured to charge or discharge a Q-node to receive input of a high-potential voltage and output a scan signal, an inverter configured to change a voltage level of a Qb-node according to a voltage level of the Q-node, and a Q-node stabilization circuit configured to discharge the Q-node to a low-potential level in response to a voltage of the Qb-node, a sensing circuit configured to sense a threshold voltage of at least one transistor included in the Q-node stabilization circuit, and a compensation circuit configured to generate a compensation value to compensate for the high-potential voltage applied to the gate driving circuit according to a result of sensing the threshold voltage.

### CROSS-REFERENCE TO RELATED APPLICATIONS

This application claims the benefit of and priority to Korean Patent Application No. 10-2024-0173646, filed on Nov. 28, 2024, the entire contents of which are incorporated herein by reference for all purposes as if fully set forth herein.

### BACKGROUND

### 1. Technical Field

The present disclosure relates to a display device and a method of driving the same.

### 2. Description of Related Art

As information technology develops, the market for display devices, which are connection media between users and information, is growing. Accordingly, the use of display devices such as light emitting display (LED) devices, quantum dot display (QDD) devices, and liquid crystal display (LCD) devices has been increasing.

Each of the display devices may include a display panel including subpixels, a driver that outputs a driving signal for driving the display panel, and a power supply that generates driving power. The driver includes a gate driving circuit that supplies gate signals such as a scan signal and a light emission control signal to the display panel, and a data driving circuit that supplies data signals to the display panel.

The gate driving circuit of the display device may be composed of a plurality of thin film transistors (TFTs). Since electrical characteristics of the TFT change over the driving time, and driving stability deteriorates, it is necessary to compensate for a high-potential gate voltage GVDD according to change in the electrical characteristics of the TFT. Therefore, technology is required to accurately sense the electrical characteristics of the TFTs included in the gate driving circuit.

The description of related art should not be considered prior art merely because it is mentioned in or associated with this section. The description of related art includes information that describes one or more aspects of the subject technology, and the description in this section does not limit the scope of the invention.

### SUMMARY

Accordingly, the present disclosure is directed to a display device and a method of driving the same that substantially obviate one or more problems due to limitations and disadvantages of the related art.

An aspect of embodiments of the present disclosure is to provide a display device and a method of driving the same capable of improving driving stability by accurately sensing and compensating for electrical characteristics of thin film transistors (TFTs) included in a gate driving circuit of the display device.

Additional advantages, aspects, and features of the disclosure will be set forth in part in the description which follows and in part will become apparent to those having ordinary skill in the art upon examination of the following or may be learned from practice of the disclosure. The aspects and other advantages of the disclosure may be realized and attained by the structure particularly pointed out in the written description and claims hereof as well as the appended drawings.

To achieve these aspects and other advantages and in accordance with the purpose of the disclosure, as embodied and broadly described herein, a display device includes a gate driving circuit including a Q-node controller configured to charge or discharge a Q-node to receive input of a high-potential voltage and output a scan signal, an inverter configured to change a voltage level of a Qb-node according to a voltage level of the Q-node, and a Q-node stabilization circuit configured to discharge the Q-node to a low-potential level in response to a voltage of the Qb-node, a sensing circuit configured to sense a threshold voltage of at least one transistor included in the Q-node stabilization circuit, and a compensation circuit configured to generate a compensation value to compensate for the high-potential voltage applied to the gate driving circuit according to a result of sensing the threshold voltage.

The Q-node stabilization circuit may include a transistor controlled by the voltage of the Qb-node input to a gate electrode to apply a low-potential voltage input to a first electrode of the transistor to the Q-node connected to a second electrode of the transistor.

The sensing circuit may include a first switch configured to connect the first electrode of the transistor to one of an initialization line that transmits an initialization voltage, a low-potential voltage line that transmits the low-potential voltage, and a sensing line that acquires a sensing value or to electrically float the first electrode, and a second switch configured to electrically separate the Qb-node into two Qb-nodes.

The Qb-node may be electrically separated into a first Qb-node maintained in a floating state and a second Qb-node whose voltage level is determined according to output of the inverter.

The sensing circuit may control the second switch so that the voltage of the Qb-node floats in a high-level state in a sensing mode for sensing a threshold voltage of the transistor, and then control the first switch so that the first electrode of the transistor electrically floats when a voltage of the Q-node connected to the second electrode of the transistor is in a high-level state.

When a reference time elapses after the first electrode of the transistor electrically floats, the sensing circuit may connect the first electrode of the transistor to the sensing line.

The transistor may perform a source following operation based on the voltage of the Q-node in the sensing mode.

After the source following operation of the transistor based on the voltage of the Q-node ends, the sensing circuit may connect the first electrode of the transistor to the sensing line.

The Q-node controller may receive input of a gate start pulse or a carry signal of a previous stage and charge the Q-node in the high-level state.

In another aspect of the present disclosure, a method of driving a display device including a gate driving circuit including a Q-node controller configured to charge or discharge a Q-node to receive input of a high-potential voltage and output a scan signal, an inverter configured to change a voltage level of a Qb-node according to a voltage level of the Q-node, and a Q-node stabilization circuit configured to discharge the Q-node to a low-potential level in response to a voltage of the Qb-node includes electrically separating the Qb-node into a first Qb-node maintained in a floating state and a second Qb-node whose voltage level is determined according to output of the inverter when a voltage of the Qb-node to which the gate electrode of the Q-node stabilization transistor is connected is in a high-level state, floating a first electrode of the Q-node stabilization transistor when a voltage of the Q-node to which a second electrode of the Q-node stabilization transistor is connected is switched to a high-level state, sensing a voltage value of the first electrode of the Q-node stabilization transistor by connecting the first electrode of the Q-node stabilization transistor to a sensing line after a preset time elapses, calculating a threshold voltage of the Q-node stabilization transistor based on the sensed voltage value, and generating a compensation value to compensate for the high-potential voltage based on the threshold voltage.

The floating a first electrode of the Q-node stabilization transistor may include performing, by the Q-node stabilization transistor, a source following operation based on the voltage of the Q-node.

It is to be understood that both the foregoing general description and the following detailed description of the present disclosure are examples and explanatory and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 is a system configuration diagram of a display device according to an embodiment of the present disclosure;

FIG. 2 is an example system implementation diagram of the display device according to an embodiment of the present disclosure;

FIG. 3 is a diagram for describing a configuration related to a gate driving circuit of the display device according to an embodiment of the present disclosure;

FIG. 4 is a diagram for describing a schematic circuit configuration of a gate-in-panel (GIP) and a sensing circuit of the display device according to an embodiment of the present disclosure;

FIGS. 5 to 7 are diagrams for describing a method of performing a sensing mode for sensing a threshold voltage of a Q-node stabilization transistor T3 in the display device according to an embodiment of the present disclosure; and

FIGS. 8 and 9 are voltage graphs for describing main driving signals of the GIP and the sensing circuit of FIG. 4 and voltage change of each node.

### DETAILED DESCRIPTION

Advantages and features of the present disclosure and a method of achieving the advantages and features will become clear with reference to the embodiments described in detail below together with the accompanying drawings. However, the present disclosure is not limited to the embodiments disclosed below and may be implemented in various different forms, and the present embodiments are provided only to make the present disclosure complete and to fully inform a person having ordinary skill in the art to which the present disclosure pertain of the scope of the invention.

The shapes, sizes, ratios, angles, numbers, etc. disclosed in the drawings to describe the embodiments of the present disclosure are illustrative, and thus the present disclosure is not limited to the illustrated matters. The same reference numerals refer to the same components throughout the specification. When the terms “include”, “have”, and “consist of”, etc. are used in the present disclosure, other parts may be added unless “only” is used. When a component is expressed in a singular form, this includes the case where the component is plural unless there is a specifically explicit description. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

When interpreting a component, the component is interpreted as including an error range even if there is no separate explicit description.

When describing a positional relationship, for example, when a positional relationship between two parts is described as “on”, “above”, “below”, “next to”, etc., one or more other parts may be located between the two parts, unless “immediately” or “directly” is used.

Even though the terms first, second, etc. may be used to describe various components, these components are not limited by these terms. These terms are only used to distinguish one component from another. Thus, a first component mentioned below may be a second component within the technical concept of the present disclosure.

A display device according to the present disclosure may be implemented as a television, a video player, a personal computer (PC), a home theater, an automobile electrical device, a smartphone, etc. However, the present disclosure is not limited thereto. The display device according to the present disclosure may be implemented as a display device (Light Emitting Display Device), a quantum dot display device, a liquid crystal display device, etc. However, for the convenience of description, a display device that directly emits light based on an inorganic light emitting diode or an organic light emitting diode is taken as an example below.

Throughout the specification, the same reference numerals refer to substantially the same components. Hereinafter, embodiments of the present disclosure will be described in detail with reference to the attached drawings. In the following description, when it is determined that a detailed description of a known function or configuration related to the present disclosure may unnecessarily obscure the gist of the present disclosure, the detailed description will be omitted.

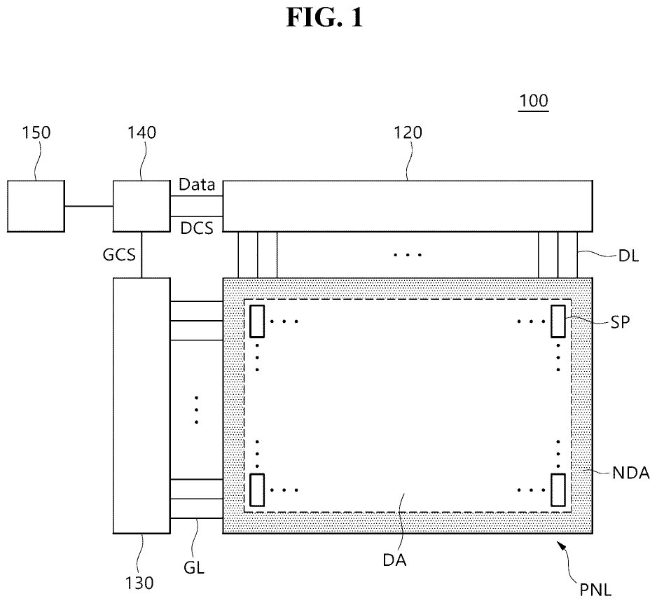

FIG. 1 is a system configuration diagram of a display device 100 according to an embodiment of the present disclosure.

Referring to FIG. 1, the display device 100 according to the embodiment of the present disclosure may include an image supply circuit 150, a controller 140, a gate driving circuit 130, a data driving circuit 120, a display panel PNL, etc.

The image supply circuit 150 may supply an image data signal supplied from an external source or an image data signal and various driving signals stored in an internal memory to the controller 140. The image supply circuit 150 may be any one of a TV Television system, a set-top box, a navigation system, a personal computer PC, a home theater system, a mobile device, and a wearable device.

The controller 140 may output a gate control signal GCS for controlling the gate driving circuit 130 and a data control signal DCS for controlling the data driving circuit 120. The controller 140 may supply a data signal Data supplied from the image supply circuit 150 together with the data control signal DCS to the data driving circuit 120. The controller 140 may be formed as an IC Integrated Circuit and mounted on a printed circuit board. However, the present disclosure is not limited thereto.

The data driving circuit 120 may convert the data signal Data into an analog data voltage and output the analog data voltage in response to the data control signal DCS supplied from the controller 140. The data driving circuit 120 may supply data voltages to subpixels SP included in the display panel PNL through data lines DL1 to DLn. The data driving circuit 120 may be formed as a plurality of source driver integrated circuits SDIC. The source driver integrated circuits SDIC may be connected to the display panel PNL by a TAB (tape automated bonding) method, connected to a bonding pad of the display panel PNL by a chip-on-glass (COG) or chip-on-panel (COP) method, or implemented using a chip-on-film (COF) method and connected to the display panel PNL. When the data driving circuit 120 includes one or more source driver integrated circuits (SDICs) and is implemented in a COF manner, each source driver integrated circuit SDIC may be mounted on a source film SF connected to a non-display area NDA of the display panel PNL. Each source driver integrated circuit SDIC may include a shift register, a latch circuit, a digital-to-analog converter DAC, an output buffer, etc. Each source driver integrated circuit SDIC may further include an analog-to-digital converter ADC, depending on the case.

The gate driving circuit 130 may supply at least one scan signal to subpixels included in the display panel 150 through gate lines GL1 to GLm. The gate driving circuit 130 may be formed as an IC or may be formed directly on the display panel 150 in a GIP manner. The gate driving circuit 130 formed in the GIP manner may be arranged on one edge of the display panel 150 or may be divided and arranged on both edges of the display panel 150.

The display panel PNL may include a plurality of data lines DL and a plurality of gate lines GL arranged in a matrix, and a plurality of subpixels SP arranged at the intersections of the data lines DL and the gate lines GL. The display panel PNL may include a display area DA where an image is displayed and the non-display area NDA where an image is not displayed. In the display area DA, a plurality of subpixels SP for displaying an image are arranged, and in the non-display area NDA, the gate driving circuit 130, the data driving circuit 120, and the controller 140 may be electrically connected or mounted, and a pad section to which an integrated circuit or a printed circuit is connected may be arranged.

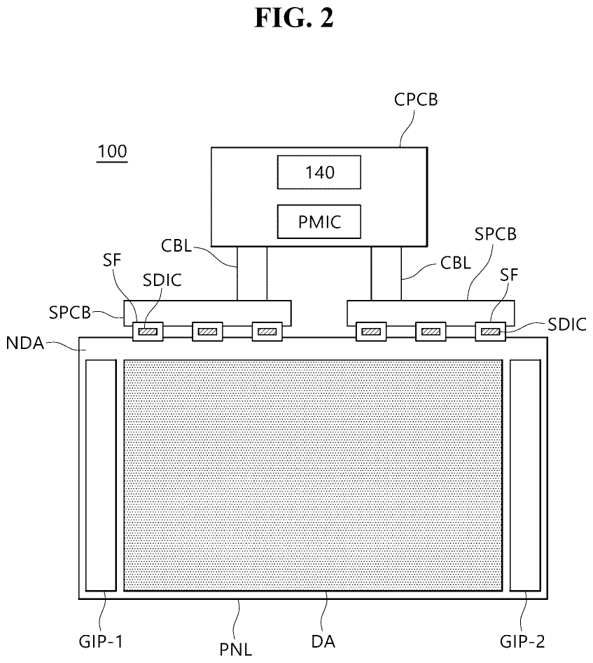

FIG. 2 is an example system implementation diagram of the display device of FIG. 1.

Referring to FIG. 1 and FIG. 2, the source driving integrated circuit SDIC included in the data driving circuit 120 is implemented using a COF method among various methods (TAB, COG, COF, etc.), and the gate driving circuit 130 is implemented in a GIP form among various methods (TAB, COG, COF, GIP, etc.).

When the gate driving circuit 130 is implemented in a GIP form, a plurality of gate driving integrated circuits GDICs included in the gate driving circuit 130 may be directly formed in the non-display area NDA of the display panel PNL. In this instance, the gate driving integrated circuit GDIC may be supplied with various signals (clock signal, gate high signal, gate low signal, etc.) necessary for generating a scan signal through gate driving-related signal wires arranged in the non-display area NDA.

One or more source driving integrated circuits SDICs included in the data driving circuit 120 may be mounted on a source film SF, and one side of the source film SF may be electrically connected to the display panel PNL. In addition, wires for electrically connecting the source driving integrated circuits SDICs and the display panel PNL may be arranged on an upper side of the source film SF.

The display device 100 may include at least one source printed circuit board SPCB for circuit connection between a plurality of source driving integrated circuits SDICs and other devices, and a control printed circuit board CPCB for mounting control components and various electrical devices.

The other side of the source film SF on which the source driving integrated circuits SDICs are mounted may be connected to the at least one source printed circuit board SPCB. That is, the source film SF on which the source drive integrated circuits SDIC are mounted may have one side electrically connected to the display panel PNL and the other side electrically connected to the source printed circuit board SPCB.

The controller 140 and a power management IC (PMIC) may be mounted on the control printed circuit board CPCB. The controller 140 may perform an overall control function related to driving of the display panel PNL and may control operations of the data driving circuit 120 and the gate driving circuit 130. The PMIC may supply various voltages or currents to the data driving circuit 120 and the gate driving circuit 130 or control various voltages or currents to be supplied. The PMIC may control a voltage or current to be supplied according to a control signal applied from a control means such as the controller 140.

The at least one source printed circuit board SPCB and the control printed circuit board CPCB may be connected via a connection cable CBL formed using a flexible printed circuit FPC, a flexible flat cable FFC, etc. Accordingly, power output from the PMIC mounted on the control printed circuit board CPCB may be applied to the display panel PNL via the connection cable CBL, the source printed circuit board SPCB, and the source film SF on which the source driver integrated circuits SDICs are mounted.

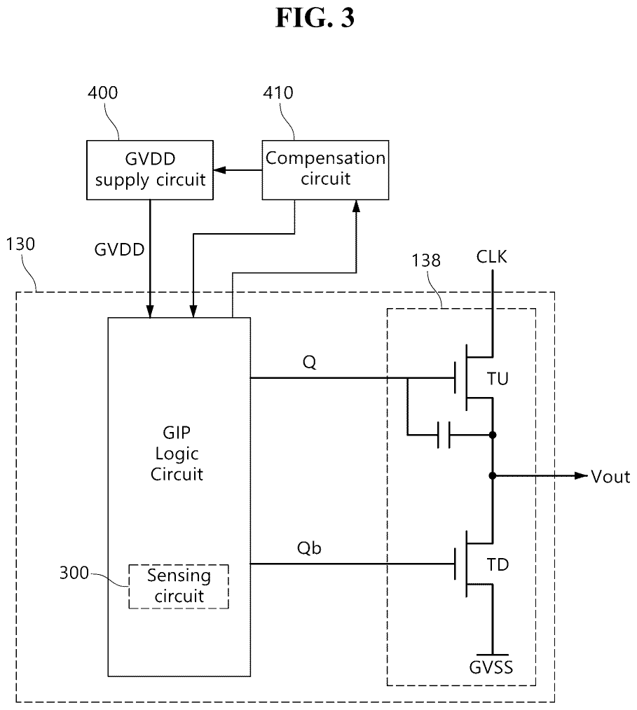

FIG. 3 is a diagram for describing a configuration related to the gate driving circuit of the display device according to an embodiment of the present disclosure.

Referring to FIG. 3, the display device according to the embodiment of the present disclosure includes the gate driving circuit 130, a GVDD supply circuit 400 that supplies a GVDD (high potential gate voltage) to the gate driving circuit 130, a sensing circuit 300 that senses electrical characteristics of a transistor included in the gate driving circuit 130, and a compensation circuit 410 that adjusts a voltage level of the GVDD applied to the gate driving circuit 130 according to a sensing result of the sensing circuit 300.

The gate driving circuit 130 may include a GIP logic circuit and an output buffer 138.

The GIP logic circuit may be implemented as a shift logic circuit including a plurality of transistors. The GIP logic circuit may be driven by being supplied with a GVDD (high potential gate voltage) and a GVSS (low potential gate voltage), which are DC voltages. The GIP logic circuit may control charging and discharging of a Q-node Q that pulls up an output voltage and a Qb-node Qb that pulls down the output voltage.

The output buffer 138 may output an output signal Vout such as a scan signal SCAN or a carry signal in response to voltage levels of the Q-node Q and the Qb-node. The output buffer 138 may include a pull-up TFT TU whose gate electrode is connected to the Q-node Q and a pull-down TFT TD whose gate electrode is connected to the Qb-node Qb. The pull-up TFT TU may be turned on when the Q-node voltage is in a high-level state and output an output signal Vout such as a scan signal SCAN or a carry signal. The pull-down TFT TD may be turned on when the Qb-node Qb is in a high-level state and output a low-level output signal Vout.

The sensing circuit 300 may sense a threshold voltage Vth of at least one of transistors included in the gate driving circuit 130 and provide a sensing value to the compensation circuit 410. Since the gate driving circuit 130 includes a plurality of transistors, deterioration and a lifespan of the gate driving circuit 130 may be determined by a transistor having the greatest deterioration among the transistors. In general, the Qb-node Qb of the gate driving circuit 130 is maintained in a low-voltage (negative voltage) state for all times except for 1 horizontal time during 1 frame period (1 frame time). Therefore, relatively large stress may be applied to a transistor controlled by a Qb-node voltage, i.e., a transistor whose gate electrode is connected to the Qb-node Qb. Therefore, in order to extend the lifespan of the gate driving circuit 130, a structure that senses and compensates for deterioration of the transistor controlled by the Qb-node voltage is desirable. Accordingly, the sensing circuit 300 may sense the threshold voltage Vth of the transistor that inputs the Qb-node voltage into the gate electrode and provide a sensing result to the compensation circuit 410.

The compensation circuit 410 may generate a compensation value that compensates for the voltage level of the GVDD according to the sensing result of the sensing circuit 300. The compensation circuit 410 may include a lookup table in which the voltage level of the GVDD is set according to the threshold voltage Vth of the transistor sensed by the sensing circuit 300. The compensation circuit 410 may be built into the controller 140 or may be provided on the CPCB.

The GVDD supply circuit 400 sets the voltage level of the GVDD by reflecting a compensation value output from the compensation circuit 410, and may supply GVDD power in which the compensation value is reflected to the gate driving circuit 130. The GVDD supply circuit 400 may be built into the PMIC or provided on the CPCB.

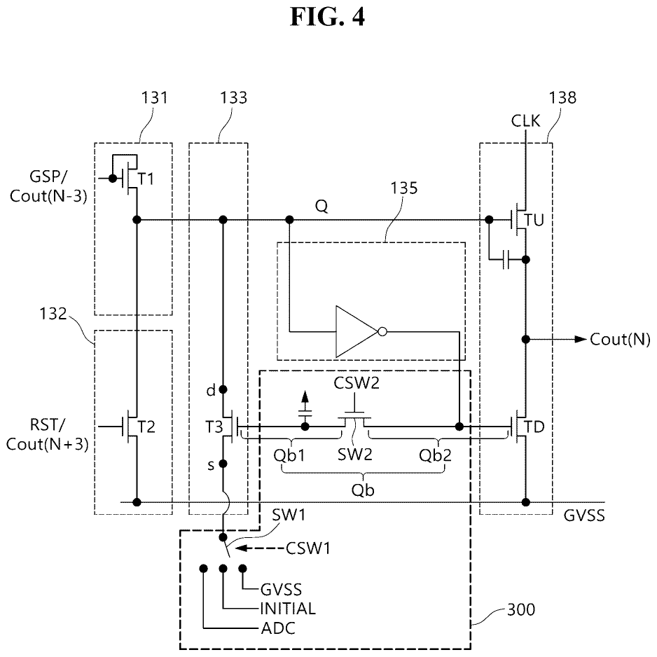

FIG. 4 is a diagram for describing a schematic circuit configuration of the GIP and the sensing circuit 300 of the display device according to the embodiment of the present disclosure. The GIP starts operating according to a gate start pulse GSP and may output a carry signal and a scan signal according to a clock signal. The scan signal output from the GIP is sequentially shifted and sequentially supplied through a gate line GL. The GIP includes a plurality of stages sequentially driven to output a scan signal, and when the scan signal is output, an Nth stage may output an Nth carry signal CoutN to a subsequent stage. Each stage of the GIP has the same TFT configuration. FIG. 4 is a diagram illustrating a schematic circuit configuration of the Nth stage and the sensing circuit 300 among the stages included in the GIP.

Referring to FIG. 4, the Nth stage of the GIP may include a Q-node charging circuit 131, a Q-node discharging circuit 132, a Q-node stabilizing circuit 133, an inverter 135, an output buffer 138, and a sensing circuit 300.

The output buffer 138 may output a carry signal CoutN based on a voltage level of a clock signal CLK or a voltage level of the GVSS, depending on the Q-node voltage or the Qb-node voltage. The output buffer 138 includes a pull-up transistor TU controlled according to the voltage level of the Q-node Q and a pull-down transistor TD controlled according to the voltage level of the Qb-node Qb opposite to the Q-node Q.

The pull-up transistor TU may have a gate electrode connected to the Q-node Q, a source electrode connected to an output terminal of an output signal VoutN, and a drain electrode connected to an input terminal of the clock signal CLK. The pull-up transistor TU may be turned on during the Q-node Q is at a high level and may output the high-level carry signal CoutN based on the clock signal CLK. A capacitor CB connected between the gate electrode and the source electrode (output terminal) of the pull-up transistor TU may reduce a rising time of the carry signal CoutN by bootstrapping and amplifying the high voltage of the Q-node Q when the pull-up transistor TU is pulled up to output a gate-on voltage of the clock signal CLK.

The pull-down transistor TD may have a gate electrode connected to the Qb-node Qb, a drain electrode connected to the output terminal of the output signal VoutN, and a source electrode connected to a supply line of the GVSS. The pull-down transistor TD may be turned on during a period when the Qb-node voltage is at a high level to transfer the GVSS power to the output terminal. Accordingly, a low-level carry signal CoutN may be output.

The Q-node charging circuit 131 may be supplied with the gate start pulse GSP applied to a start terminal or a carry signal Cout(N−3) of a preceding stage to charge the Q-node Q. The Q-node charging circuit 131 may include one or more Q charging transistors T1 having a gate electrode and a drain electrode connected to the start terminal and a source electrode connected to the Q-node Q. The Q charging transistor T1 may be turned on when the gate start pulse GSP or the carry signal Cout(N−3) of the (N−3)th preceding stage is at a high voltage to charge the Q-node Q with a high voltage.

The Q-node discharging circuit 132 may discharge the Q-node Q to GVSS (low potential gate voltage) in response to a reset signal RST applied to a reset terminal or a carry signal Cout(N+3) of a subsequent stage. The Q-node discharging circuit 132 may include one or more Q discharge transistors T2 having a gate electrode connected to the reset terminal, a source electrode connected to the GVSS supply line, and a drain electrode connected to the Q-node Q. The Q discharge transistor T2 may be turned on when the reset signal RST or the carry signal Cout(N+3) of the subsequent stage is at a high voltage to discharge the Q-node Q to a GVSS voltage, which is a low voltage.

The Q-node stabilization circuit 133 may discharge the Q-node voltage to the GVSS in response to the Qb-node voltage at a high level. The Q-node stabilization circuit 133 may include one or more Q-node stabilization transistors T3 having a gate electrode connected to the Qb-node Qb, a first electrode connected to the GVSS supply line, and a second electrode connected to the Q-node Q. Here, the Qb-node Qb has a structure in which a low-level voltage is continuously applied, and thus relatively large stress may be applied to the Q-node stabilization transistor T3. That is, since the Q-node stabilization transistor T3 is a device that is vulnerable to fluctuation in the threshold voltage Vth among the transistors included in the GIP, stress of the GIP may be effectively reduced by adjusting the GVDD voltage based on the threshold voltage Vth of the Q-node stabilization transistor T3.

The inverter 135 may change a Qb-node voltage level according to a Q-node voltage level. When the Q-node voltage is in a high-level state, the inverter 135 may change the Qb-node voltage to a low-level state. The inverter 135 may change the Qb-node voltage to a high-level state when the Q-node voltage is in a low-level state.

The sensing circuit 300 may sense the threshold voltage Vth of the Q-node stabilization transistor T3 and provide a sensing value to the compensation circuit 410. The sensing circuit 300 may include a first switch SW1 that operates by receiving input of a first switch signal CSW1 and a second switch SW2 that operates by receiving input of a second switch signal CSW2. The first and second switch signals CSW1 and CSW2 may be output from the compensation circuit 410. However, the present disclosure is not limited thereto, and the switch signals may be output from a configuration that controls a sensing mode that senses the threshold voltage Vth of the Q-node stabilization transistor T3.

The first switch SW1 may have one end connected to a source node s to which the first electrode of the Q-node stabilization transistor T3 is connected, and the other end connected to any one of a GVSS line GVSSL, an initialization line INITIAL, and a sensing line (analog-digital converter ADC) or not connected to any one of these lines. The first switch SW1 may be turned on by the first switch signal CSW1 to connect the source node s of the Q-node stabilization transistor T3 to any one of the GVSS line GVSSL, the initialization line INITIAL, and the sensing line ADC, or may be turned off to float the source node s of the Q-node stabilization transistor T3.

When the first switch SW1 is connected to the GVSS line GVSSL, the GVSS is applied to the source node s of the Q-node stabilization transistor T3. When the GIP is operating in normal mode, the first switch SW1 may remain connected to the GVSS line GVSSL.

When the first switch SW1 is connected to the initialization line INITIAL, an initialization voltage is applied to the source node s of the Q-node stabilization transistor T3. The initialization voltage may be applied to initialize a voltage of the source node s when sensing the threshold voltage Vth of the Q-node stabilization transistor T3.

When the first switch SW1 is connected to the sensing line ADC, a voltage sensing value of the source node s of the Q-node stabilization transistor T3 may be transmitted to the compensation circuit 410. The compensation circuit 410 may check the sensing value through the ADC. The ADC is a general configuration that samples and holds a continuous analog signal and converts the analog signal into a digital signal. The ADC connected to the sensing line ADC may convert the voltage of the source node s of the Q-node stabilization transistor T3 into a digital sensing value. Such an ADC may be included in the sensing circuit 300 or the compensation circuit 410 to generate a sensing value in the form of a digital signal.

When the first switch SW1 is turned off and not connected to any line, the source node s of the Q-node stabilization transistor T3 may be electrically floated.

The second switch SW2 may be controlled by the second switch signal CSW2 to electrically separate the Qb-node Qb into a first Qb-node Qb1 and a second Qb-node Qb2 or connect the nodes. The first Qb-node Qb1 may be a node to which the gate electrode of the Q-node stabilization transistor T3 is connected. The second Qb-node Qb2 may be a node to which output of the inverter 135 and the gate electrode of the pull-down transistor TD are connected.

When the second switch SW2 is turned on, the first Qb-node Qb1 and the second Qb-node Qb2 are electrically interconnected to operate as a single Qb-node Qb. The Qb-node Qb may have a voltage level opposite to that of the Q-node Q by a signal applied from the inverter 135. When the second switch SW2 is turned off, the Qb-node may be electrically separated into the first Qb-node Qb1 and the second Qb-node Qb2. When the first Qb-node Qb1 and the second Qb-node Qb2 are electrically separated from each other, the first Qb-node Qb1 floats at a voltage level before separation, and a voltage level of the second Qb-node Qb2 may be determined according to a signal applied from the inverter 135. For example, in a state in which the second switch SW2 is turned on and a voltage of the Qb-node Qb1+Qb2 is at a high level, when the second switch SW2 is turned off, the first Qb-node Qb1 floats in a state of a high-level voltage. The second Qb-node Qb2 may be switched to a low-level state by a signal applied from the inverter 135. That is, when the Q-node voltage is switched to a high level in a state in which the second switch SW2 is turned off, the voltage of the second Qb-node connected to the inverter 135 is switched to a low level. However, the first Qb-node voltage may remain in a high-level voltage state.

The sensing circuit 300 having such a configuration may electrically separate the Qb-node Qb charged with a high-level voltage, apply a high-level signal to the gate electrode of the Q-node stabilization transistor T3, and float the source node s connected to the first electrode of the Q-node stabilization transistor T3. Accordingly, source following driving may be performed based on the Q-node voltage at a high-level applied to a drain node d connected to the second electrode of the Q-node stabilization transistor T3, thereby sensing the threshold voltage Vth.

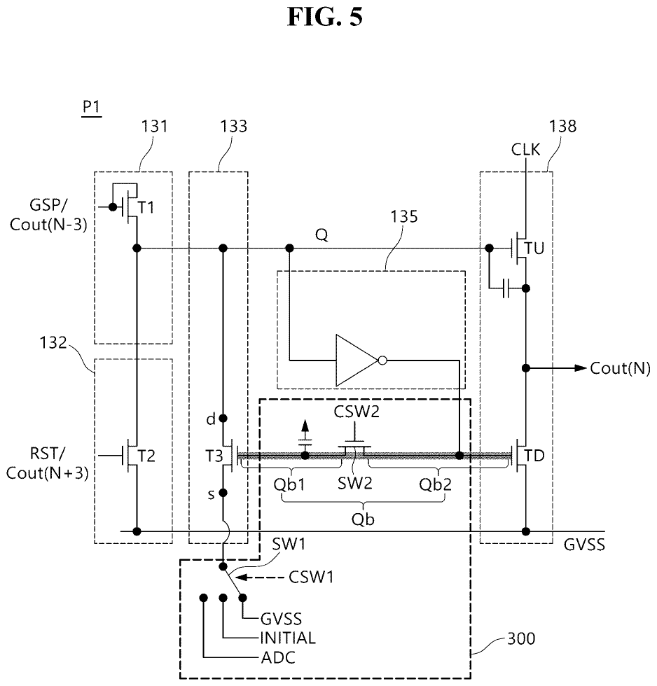

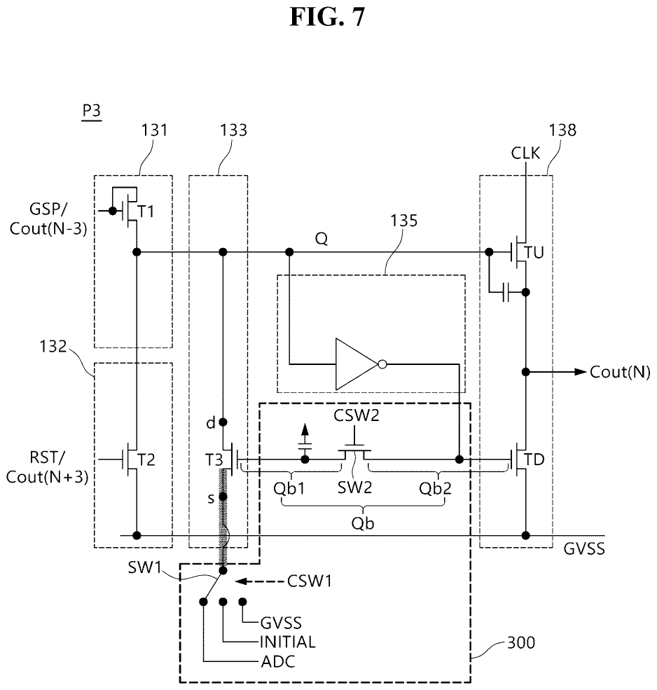

FIGS. 5 to 7 are drawings for describing a method of sensing the threshold voltage Vth of the Q-node stabilization transistor T3 in the display device according to an embodiment of the present disclosure.

The sensing mode for sensing the threshold voltage Vth of the Q-node stabilization transistor T3 may include first to third periods P1 to P3. FIGS. 5 to 7 illustrate circuit operations of the GIP and the sensing circuit 300 in the first to third periods P1 to P3, respectively.

FIG. 5 illustrates circuit operations of the GIP and the sensing circuit 300 in the first period P1. The first period P1 of the sensing mode is a Qb-node voltage charging period, and when the Qb-node voltage is in a high-level state, operation of the first period P1 may be performed. For example, when the GIP is in a standby state before starting an operation for outputting a scan signal, the Q-node voltage may be in a low-level state and the Qb-node voltage may be in a high-level state.

In the first period P1 of the sensing mode, the first switch SW1 is connected to the GVSS line GVSSL and the second switch SW2 is turned on.

In the first period P1, the first switch SW1 may connect the source node s of the Q-node stabilization transistor T3 to the GVSS line GVSSL according to the first switch signal CSW1. When the first switch SW1 is connected to the GVSS line GVSSL, the GVSS is applied to the source node s of the Q-node stabilization transistor T3.

The second switch SW2 may be turned on according to the second switch signal CSW2 to electrically interconnect the first Qb-node Qb1 and the second Qb-node Qb2. Since the Qb-node voltage is in a high-level state, both the first Qb-node Qb1 and the second Qb-node Qb2 may be charged with a high level.

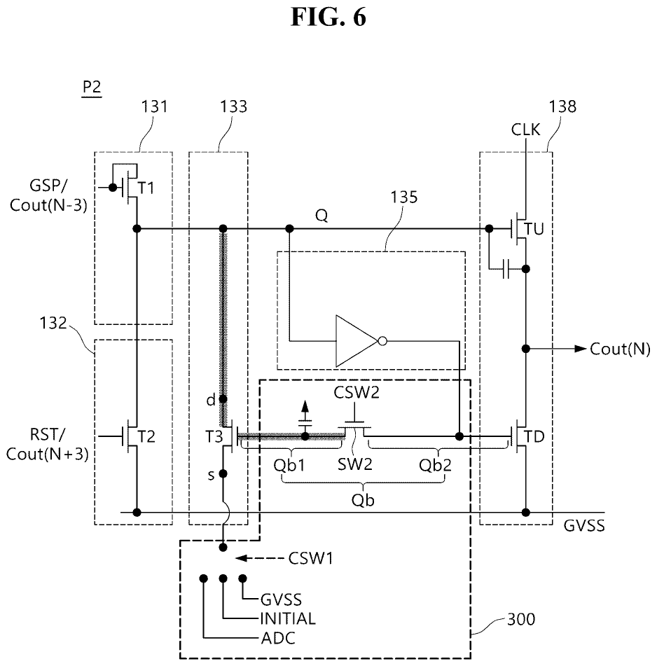

FIG. 6 illustrates a circuit operation of the GIP and sensing circuit 300 in the second period P2.

The second period P2 of the sensing mode may be performed when the Q-node voltage is switched to a high-level state. For example, when the gate start pulse GSP or the carry signal Cout(N−3) of the preceding stage is applied to the Q-node charging circuit 131, the Q-node voltage may be charged with a high-level. When the Q-node voltage is charged with the high-level, the inverter 135 outputs a low-level voltage signal to the Qb-node Qb. Accordingly, the Q-node voltage and the Qb-node voltage may be switched to opposite voltage level states in conjunction with each other.

In the second period P2 of the sensing mode, the Q-node voltage is charged with a high level, the first switch SW1 is turned off, and the second switch SW2 is turned on.

In the second period P2, the first switch SW1 may be turned off according to the first switch signal CSW1 and may not be connected to any line. When the first switch SW1 is turned off and is not connected to any line, the source node s of the Q-node stabilization transistor T3 may be electrically floated.

The second switch SW2 may be turned off according to the second switch signal CSW2. When the second switch SW2 is turned off, the Qb-node Qb may be electrically separated into the first Qb-node Qb1 and the second Qb-node Qb2. The first Qb-node Qb1 may be floated in a high-level state before being separated. The second Qb-node Qb2 may be switched to a low-level state according to a low-level signal applied from the inverter 135.

According to the circuit operation above, the voltage of the first Qb-node Qb1 is reflected in the gate electrode of the Q-node stabilization transistor T3, and a high-level signal is applied to the gate electrode of the Q-node stabilization transistor T3. The voltage of the Q-node Q is applied to the drain node d of the Q-node stabilization transistor T3, and the Q-node voltage may have a relatively higher voltage level than that of the first Qb-node voltage. The source node s of the Q-node stabilization transistor T3 is in a floating state. In a state where the first Qb-node voltage at a high level is applied to the gate electrode of the Q-node stabilization transistor T3, a Q-node voltage having a relatively higher potential than that of the first Qb-node voltage is applied to the drain node d. Therefore, the Q-node stabilization transistor T3 is driven in source following by the Q-node voltage of the drain node d, so that the voltage of the source node s fluctuates by the threshold voltage Vth more than the voltage of the gate electrode. That is, a current flows from the drain node d to the source node s according to the gate-source voltage Vgs, so that the potential of the source node s gradually increases, and when a potential difference between the source node s and the gate electrode becomes the threshold voltage Vth, the current flow is stopped, so that the voltage of the source node s may be determined. Since the first Qb-node voltage applied to the gate electrode may be known in advance, the threshold voltage Vth of the Q-node stabilization transistor T3 may be calculated by sensing the voltage of the source node s and calculating a difference therebetween.

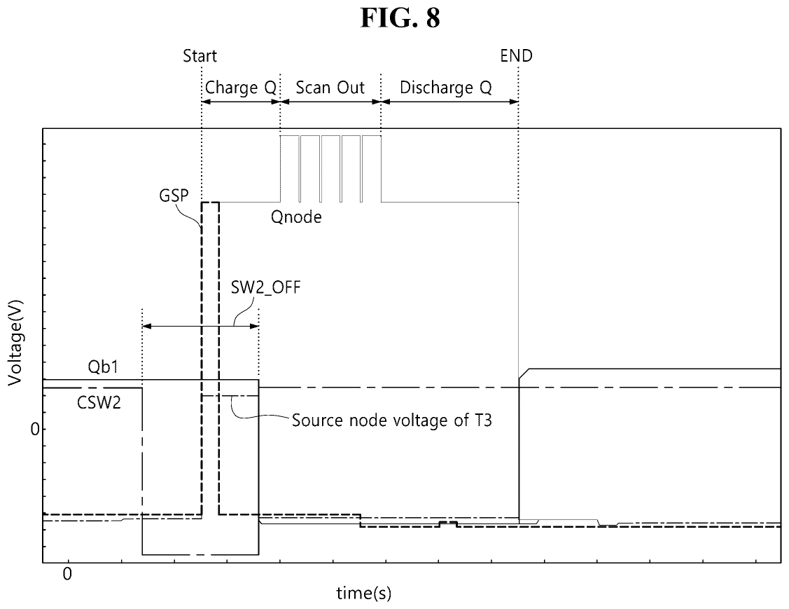

FIG. 8 illustrates a circuit operation of the GIP and the sensing circuit 300 in the third period P3.

In the third period P3 of the sensing mode, the first switch SW1 may be connected to the sensing line ADC according to the first switch signal CSW1. When the first switch SW1 is connected to the sensing line ADC, the voltage of the source node s of the Q-node stabilization transistor T3 may be provided to the compensation circuit 410.

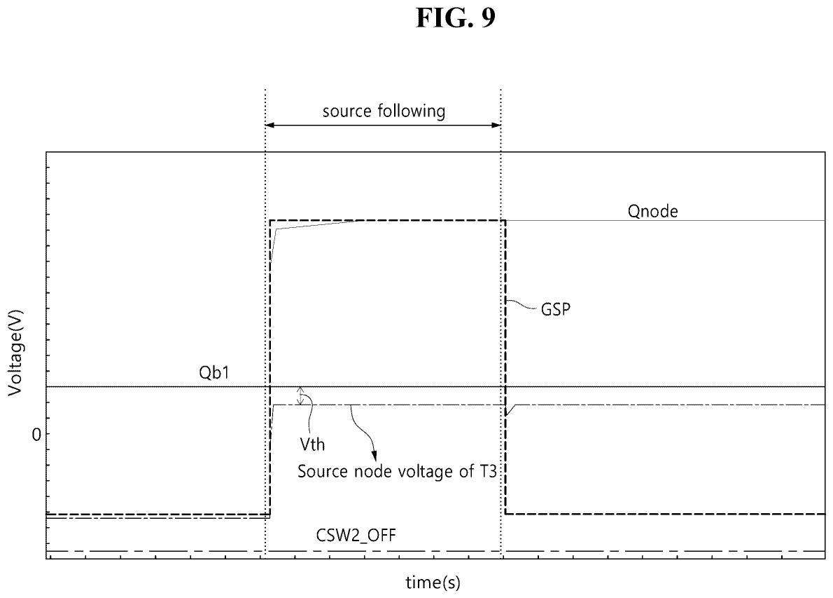

FIG. 8 and FIG. 9 are voltage graphs for describing main driving signals of the GIP and the sensing circuit 300 of FIG. 4 and voltage change of each node. FIG. 8 is a graph illustrating changes in the Q-node voltage Qnode, the first Qb-node voltage Qb1, the voltage of the source node s of the Q-node stabilization transistor T3, and voltages of the second switch signal CSW2 and the gate start pulse GSP, and FIG. 9 is a graph illustrating an enlarged section of a part of the graph of FIG. 8.

As shown in the graph of the Q-node voltage Qnode of FIG. 8, when a GSP signal is input and a GIP operation starts, the Q-node voltage Qnode is charged with a high level, scan signals are sequentially output, the Q-node voltage Qnode is discharged, and then the operation may be ended.

Before the GSP signal is input, the Qb-node voltage is maintained at a high level in a standby state. Before the GSP signal is input, when the second switch signal CSW2 is applied at a high level, the second switch SW2 is turned on, and the first Qb-node Qb1 and the second Qb-node Qb2 are electrically interconnected. Therefore, both the first Qb-node voltage and the second Qb-node voltage may be charged with a high level.

Thereafter, when the second switch signal CSW2 is applied at a low level, the second switch SW2 is turned off (SW2_OFF). The second switch signal CSW2 may be applied at a low level at any point in time when the Qb-node voltage is in a high-level state. When the second switch SW2 is turned off, the Qb-node Qb is electrically separated into the first Qb-node Qb1 and the second Qb-node Qb2. Accordingly, the first Qb-node voltage may be maintained in a previously charged high-level state. The second Qb-node voltage may be switched to a low-level state according to output of the inverter 135. That is, even when the Q-node voltage is switched to a high level while the second switch SW2 is in an off state (SW2_OFF), the first Qb-node voltage may be floated and maintained in a high-level state.

Thereafter, when the GSP signal is input and the Q-node voltage Qnode is switched to a high level, source following driving for sensing the threshold voltage Vth of the Q-node stabilization transistor T3 may be performed. As illustrated in FIG. 9, during source following driving, the source node s of the Q-node stabilization transistor T3 is maintained in a floating state, and thus the voltage of the source node s of the Q-node stabilization transistor T3 may rise to a voltage level that is different by the threshold voltage Vth from the voltage of the first Qb-node Qb1 input to the gate electrode. Accordingly, the threshold voltage Vth may be calculated by sensing the voltage of the source node s of the Q-node stabilization transistor T3.

As described above, the display device according to the embodiment of the present disclosure may perform a control operation so that, during any period in which the Qb-node voltage is in a high-level state, the Qb-node is electrically separated and maintained in a high-level state, the source electrode of the Q-node stabilization transistor T3 is maintained in a floating state, and when the Q-node is charged with a voltage in a high-level state, the Q-node stabilization transistor T3 may be driven in source following based on the Q-node voltage. Accordingly, the threshold voltage Vth of the Q-node stabilization transistor T3 vulnerable to deterioration in the GIP may be directly sensed to compensate for the GVDD, so that stress applied to the GIP may be effectively relieved, thereby improving driving reliability and driving stability.

Embodiments of the present disclosure provide a display device and a method of driving the same capable of improving driving stability.

Embodiments of the present disclosure provide a display device and a method of driving the same capable of improving driving reliability and driving stability of a gate driving circuit by accurately sensing electrical characteristics of TFTs included in the gate driving circuit and adjusting a GVDD voltage.

Embodiments of the present disclosure provide a display device and a method of driving the same capable of effectively reducing stress applied to a gate driving circuit and ensuring driving reliability and driving stability by directly accurately sensing a threshold voltage of a Q-node stabilization transistor included in the gate driving circuit and compensating for a GVDD voltage.

The effects of the present disclosure are not limited to those illustrated above, and the present disclosure encompasses a wider variety of effects.

In one or more examples, the term “high-level” may indicate a level that is higher than “low-level”. In one or more examples, a Q-node, a Qb-node and the like may be used herein to describe various nodes. These nodes should not be limited by these terms, for example, to any particular order, precedence, or number of nodes. These terms are used only to distinguish one node from another. Furthermore, a Q-node, a Qb-node and the like may be arbitrarily named for convenience without departing from the scope of the present disclosure. For clarity, the functions or structures of these nodes (e.g., a Q-node, a Qb-node and the like) are not limited by the names in front of the nodes. Further, a Q-node may include one or more Q-nodes. Similarly, a Qb-node or the like may include one or more a Qb-nodes or the like.

The description herein has been presented to enable any person skilled in the art to make, use and practice the technical features of the present disclosure, and has been provided in the context of one or more particular example applications and their example requirements. Various modifications, additions and substitutions to the described embodiments will be readily apparent to those skilled in the art, and the principles described herein may be applied to other embodiments and applications without departing from the scope of the present disclosure. The description herein and the accompanying drawings provide non-limiting examples of the technical features of the present disclosure for illustrative purposes. In other words, the disclosed embodiments illustrate the scope of the technical features of the present disclosure and are not intended to be limiting in any respect. Thus, the scope of the present disclosure is not limited to the embodiments shown, but is to be accorded the widest scope consistent with the claims and their equivalents.

What is claimed is:

1. A display device, comprising:
a gate driving circuit comprising a Q-node controller configured to charge or discharge a Q-node to receive input of a high-potential voltage and output a scan signal, an inverter configured to change a voltage level of a Qb-node according to a voltage level of the Q-node, and a Q-node stabilization circuit configured to discharge the Q-node to a low-potential level in response to a voltage of the Qb-node;
a sensing circuit configured to sense a threshold voltage of at least one transistor included in the Q-node stabilization circuit; and
a compensation circuit configured to generate a compensation value to compensate for the high-potential voltage applied to the gate driving circuit according to a result of sensing the threshold voltage.

2. The display device according to claim 1, wherein the Q-node stabilization circuit comprises a transistor controlled by the voltage of the Qb-node input to a gate electrode to apply a low-potential voltage input to a first electrode of the transistor to the Q-node connected to a second electrode of the transistor.

3. The display device according to claim 2, wherein the sensing circuit comprises:
a first switch configured to connect the first electrode of the transistor to one of an initialization line that transmits an initialization voltage, a low-potential voltage line that transmits the low-potential voltage, and a sensing line that acquires a sensing value, or configured to electrically float the first electrode; and
a second switch configured to electrically separate the Qb-node into two Qb-nodes.

4. The display device according to claim 3, wherein the Qb-node is electrically separated into a first Qb-node maintained in a floating state and a second Qb-node whose voltage level is determined according to output of the inverter.

5. The display device according to claim 4, wherein the sensing circuit is configured to control the second switch so that the voltage of the Qb-node floats in a high-level state in a sensing mode for sensing a threshold voltage of the transistor, and then is configured to control the first switch so that the first electrode of the transistor electrically floats when a voltage of the Q-node connected to the second electrode of the transistor is in a high-level state.

6. The display device according to claim 5, wherein, when a reference time elapses after the first electrode of the transistor electrically floats, the sensing circuit connects the first electrode of the transistor to the sensing line.

7. The display device according to claim 5, wherein the transistor performs a source following operation based on a voltage of the Q-node in the sensing mode.

8. The display device according to claim 7, wherein, after the source following operation of the transistor based on a voltage of the Q-node ends, the sensing circuit connects the first electrode of the transistor to the sensing line.

9. The display device according to claim 5, wherein the Q-node controller is configured to receive input of a gate start pulse or a carry signal of a previous stage and to charge the Q-node in the high-level state.

10. A method of driving a display device comprising a gate driving circuit comprising a Q-node controller configured to charge or discharge a Q-node to receive input of a high-potential voltage and output a scan signal, an inverter configured to change a voltage level of a Qb-node according to a voltage level of the Q-node, and a Q-node stabilization circuit configured to discharge the Q-node to a low-potential level in response to a voltage of the Qb-node, the method comprising following steps:
electrically separating the Qb-node into a first Qb-node maintained in a floating state and a second Qb-node whose voltage level is determined according to output of the inverter when a voltage of the Qb-node to which a gate electrode of the Q-node stabilization circuit is connected is in a high-level state;
floating a first electrode of the Q-node stabilization circuit when a voltage of the Q-node to which a second electrode of the Q-node stabilization circuit is connected is switched to a high-level state;
sensing a voltage value of the first electrode of the Q-node stabilization circuit by connecting the first electrode of the Q-node stabilization circuit to a sensing line after a preset time elapses;
calculating a threshold voltage of the Q-node stabilization circuit based on the sensed voltage value; and
generating a compensation value to compensate for the high-potential voltage based on the threshold voltage.

11. The method according to claim 10, wherein in an operation of the floating the first electrode of the Q-node stabilization circuit when the voltage of the Q-node to which the second electrode of the Q-node stabilization circuit is connected is switched to the high-level state, the Q-node stabilization circuit performs a source following operation based on the voltage of the Q-node.
